(19) United States
(12) Patent Application Publication
(10) Pub. No.: US 2017/0168795 A1
(43) Pub. Date: Jun. 15, 2017

(54) METHOD AND SYSTEM FOR MANAGING MICRO RELEASE AUTOMATION IN AN APPLICATION DELIVERY SYSTEM

(71) Applicant: OPEX LABS INDIA LLP, BANGALORE (IN)

(72) Inventors: VIVEKANANDAN MUTHUKRISHNAN, BANGALORE (IN); ASHWIN BASAVARAJA, BANGALORE (IN); VENGADESSIN PERUMAL, BANGALORE (IN)

(21) Appl. No.: 15/019,626

(22) Filed: Feb. 9, 2016

(30) Foreign Application Priority Data
Dec. 9, 2015 (IN) 6592/CHE/2015

(51) Int. Cl. G06F 9/445; H04L 29/08

(52) U.S. Cl. CPC G06F 8/61; H04L 67/34

(57) ABSTRACT

The present invention relates to a method and system for managing micro release automation in an application delivery system. The method includes generating, by a build server, a second mount action version of a second installation package for at least one target process of a target application. The at least one target process operates based on a first installation package including a first mount action version. The second installation package is stored within a mount action repository that includes the first installation package. The method further includes broadcasting a mount action change event message for the at least one target process to at least one target node of the application delivery system. The mount action change event message is broadcasted based on detection of the second installation package in the mount action repository. The mount action change event message includes geospatial data of the at least one target node.

### CROSS-REFERENCE TO RELATED APPLICATIONS

This non-provisional application claims priority to Indian Non-Provisional Patent Application No. 6592/CHE/2015, filed on Dec. 9, 2015, which is incorporated herein by reference in its entirety.

### FIELD OF THE INVENTION

The present invention generally relates to application delivery systems and more particularly to a method and system for managing micro release automation in an application delivery system.

### BACKGROUND TO THE INVENTION

In a typical application delivery system, upgrades and installations (or releases) are constantly being generated for target applications on target servers or target devices. Existing processes of the upgrades and the installations involve complete replacement of executable or libraries in the target applications, which is a wastage of time and resources. Further, during any upgrades and installation issues, roll back of the upgrades and the installations follow complicated procedures and are time consuming, especially in the application delivery system including multiple servers in a datacenter. Moreover, datacenter operators of the datacentre find difficulty in controlling application delivery and update processes in such an application delivery system. Further, users installing multiple applications on target devices also face space shortages on the target devices leading to the users being dissatisfied with overall user experience.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

An example of a computer-implemented method of managing micro release automation in an application delivery system includes generating, by a build server, a second mount action version of a second installation package for at least one target process of a target application. The at least one target process operates based on a first installation package including a first mount action version. The method also includes storing, by the build server, the second installation package including the second mount action version within a mount action repository. The first installation package including the first mount action version is present within the mount action repository. Further, the method includes broadcasting, by the build server, a mount action change event message for the at least one target process to at least one target node of the application delivery system. The mount action change event message is broadcasted based on detection of the second installation package in the mount action repository. The mount action change event message includes geospatial data of the at least one target node.

An example of a computer-implemented method of managing micro release automation in an application delivery system includes receiving, by a target node, a mount action change event message for at least one target process of a target application from a build server of the application delivery system. The at least one target process operates based on a first installation package including a first mount action version. The mount action change event message includes information corresponding to a second mount action version built for a second installation package. The method also includes obtaining, by the target node, the second installation package from the build server if the second installation package is relevant for the target node. The method further includes identifying, by the target node, the at least one target process to be controlled at a scheduled time interval based on the second installation package. Further, the method includes creating, by the target node, an isolated mount runtime environment for the at least one target process based on the second mount action version. The isolated mount runtime environment is created by creating a clone mount namespace. The method also includes performing, by the target node, one or more mount actions for the at least one target process in response to the clone mount namespace. The one or more mount actions are performed based on the second mount action version. Moreover, the method includes initiating, by the target node, the at least one target process from the isolated mount runtime environment to enable visibility of the one or more mount actions.

An example of a build server implemented in an application delivery system, the build server in operative communication with at least one target node associated with the application delivery system, includes a mount action command generator configured to generate a second mount action version of a second installation package for at least one target process of a target application. The at least one target process operates based on a first installation package including a first mount action version. The build server also includes a mount action repository coupled to the mount action command generator and configured to store the second installation package including the second mount action version. The first installation package includes the first mount action version present within the mount action repository. The build server further includes a mount action broadcast agent coupled to the mount action repository and configured to broadcast a mount action change event message for the at least one target process to the at least one target node of the application delivery system. The mount action change event message is broadcasted based on detection of the second installation package in the mount action repository. The mount action change event message includes geospatial data of the at least one target node.

An example of a target node implemented in an application delivery system, the target node in operative communication with a build server associated with the application delivery system, includes an event processor. The event processor includes a listener agent module configured to receive a mount action change event message for at least one target process of a target application from a build server of the application delivery system. The at least one target process operates based on a first installation package including a first mount action version. The mount action change event message includes information corresponding to a second mount action version built for a second installation package. The listener agent module is also configured to obtain the second installation package from the build server if the second installation package is relevant for the target node. The listener agent module is further configured to identify the at least one target process to be controlled at a scheduled time interval based on the second installation package. Further, the listener agent module is configured to create an isolated mount runtime environment for the at least one target process based on the second mount action version. The isolated mount runtime environment is created by creating a clone mount namespace. The listener agent module is also configured to perform one or more mount actions for the at least one target process in response to the clone mount namespace. The one or more mount actions are performed based on the second mount action version. Moreover, the listener agent module is also configured to initiate the at least one target process from the isolated mount runtime environment to enable visibility of the one or more mount actions.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

The invention will be described and explained with additional specificity and detail with the accompanying figures in which;

FIG. 1 is an example representation of an application delivery system, in accordance with an embodiment;

FIG. 2 is a block diagram representation of a build server, in accordance with an embodiment;

FIG. 3 is a block diagram representation of a target node, in accordance with an embodiment;

FIG. 4 illustrates an example flow diagram of a method for managing micro release automation in an application delivery system, in accordance with an embodiment;

FIG. 5 illustrates an example flow diagram of a method for managing micro release automation in an application delivery system, in accordance with an embodiment; and

FIG. 6 illustrates a block diagram of an electronic device, in accordance with one embodiment.

Further, skilled artisans will appreciate that elements in the FIGS. are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

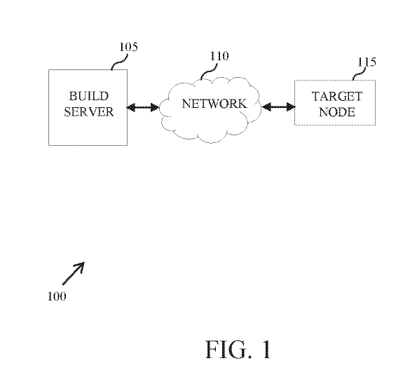

FIG. 1 is an example representation of an application delivery system 100, in accordance with an embodiment. The application delivery system 100 is used for micro release automation and includes a build server 105, a network 110, and a target node 115. Herein, the ‘micro release automation’ refers to releases of application changes or change events that are instantly made available to target nodes connected over the network 110. FIG. 1 is explained with respect to a single build server, for example the build server 105, and a single target node, for example the target node 115. However, it should be noted that a plurality of build servers other than the build server 105 and a plurality of target nodes other than the target node 115 can also be similarly included in the application delivery system 100. The build server 105 communicates with the target node 115 through the network 110. The target node 115 can either be a target server or a target device. Examples of the target node 115 include, but are not limited to, computers, mobile devices, tablets, laptops, palmtops, handheld devices, telecommunication devices, personal digital assistants (PDAs), and the like. Examples of the network 110 includes, but are not limited to, a Local Area Network (LAN), a Wireless Local Area Network (WLAN), a Wide Area Network (WAN), internet, a Small Area Network (SAN), a Storage Area Network (SAN), and the like.

The build server 105 is used to generate a second mount action version for at least one target process of a target application by capturing dependencies between application executable and relevant libraries (for example dynamic linked library (DLL) or shared objects) (also referred to as metadata captured in JSON or XML formats) of a target application. In some embodiments, the dependencies are captured by obtaining one or more modules from one or more build servers or external servers over the network 110. The dependencies can hence be captured in such a manner as a single mount action can have a dependency within another application executable or library not relevant to the build server 105. Herein, the ‘mount action’ refers to an application executable, a library, or a configuration file that can be obtained over the network 110, either from the build server 105 or an external server using an appropriate network protocol. The application executable and the relevant libraries are available over a secure or no secure transport endpoints over user datagram protocol (UDP), transmission control protocol (TCP) or similar networking protocols. The second mount action version is further generated based on a plurality of mount action definitions. The build server 105 stores the second mount action version along with a second target application bundle using one or more file formats, for example ZIP, TAR, RPM, DEB, GZ, and the like. The second mount action version and the second target application bundle together constitute a second installation package. The build server 105 further includes other versions of installation packages, for example a first installation package including a first mount action version and a first target application bundle. The build server 105 broadcasts a mount action change event message over the network 110. The target node 115 receives the mount action change event message and verifies relevancy. In an example, the one or more build servers in the application delivery system 100 can coordinate with each other to broadcast the mount action change event message to one or more target nodes.

If the mount action change event message is relevant for the target node 115, the second installation package is obtained from the build server 105 and the at least one target process of the target application that are to be controlled are further identified. The mount action change event message is further dropped if relevancy is not determined for the target node 115. The target node 115 further creates an isolated mount runtime environment and performs one or more mount actions based on the second mount action version. The at least one target process is then initiated and, if successful, system configurations are applied to the at least one target process else the at least one target process is reverted back (or rolled back) to operate based on the first mount action version of the first installation package. If there are repeated failures for initiating the at least one target process, the target node 115 informs the build server 105 through log messages. In some embodiments, the target node is based on a stateless application delivery model in which users can run one or more versions of an application in parallel. For example, the first mount action version and the second mount action version can be run in parallel. Such operation can be automated from the build server 105 or by invoking appropriate interface commands on the target node 115.

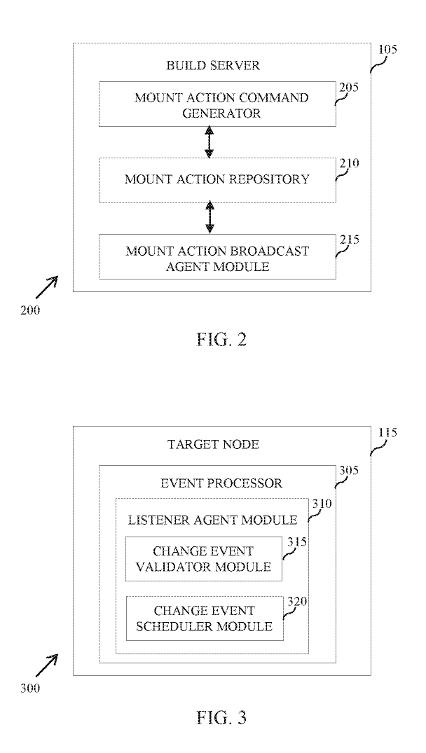

An example embodiment of the build server 105 is explained with reference to FIG. 2 and an example embodiment of the target node 115 is explained with reference to FIG. 3.

FIG. 2 is a block diagram representation 200 of the build server 105, in accordance with an embodiment. The build server 105 includes a mount action command generator 205, a mount action repository 210, and a mount action broadcast agent module 215. In some embodiments, the mount action repository 110 can be present external to the build server 105.

The mount action command generator 205 is configured to generate the second mount action version of the second installation package. Herein, the ‘second mount action version’ refers to a mount action version that is built to update an existing mount action version, for example the first mount action version of the first installation package. The mount action command generator 205 builds the second mount action version for the at least one target process. In an example, the second installation package includes a second mount action version v1.0.1 along with a second target application bundle (of version 1.0.1), and the first installation package includes a first mount action version v1.0.0 along with a first target application bundle (of version 1.0.0). In an example, the first mount action version and the second mount action version are built using one or more of JSON, XML, a text file, and the like file formats, for easy communication of the mount action change event message over the network 110.

The second mount action version is further built or generated based on a plurality of mount action definitions defined by the mount action command generator 205. In an example, the mount action command generator 205 defines a first mount action definition relating to dependencies between the application executable and the relevant libraries (also referred to as the metadata) of the target application. The application executable includes source mount path executable and target mount path executable. In an example, the mount action command generator 205 defines a second mount action definition relating to information of impacted users and target processes. In another example, the mount action command generator 205 defines a third mount action definition relating to user or target process specific security and system resource allocation policies, or attaching a disk or file over the network 110 for a user and target application processes. Some examples of the system resource allocation policies include % central processing unit (CPU), % MEMORY, % DISKIO, and the like. In an example, the mount action command generator 205 defines a fourth mount action definition relating to specifications of the target node 115, for example version of operating system, architecture and the like. In an example, the mount action command generator 205 defines a fifth mount action definition relating to parent mount action version references, for example the first mount action version, along with current mount action version reference, for example the second mount action version.

The mount action command generator 205 stores the second mount action version in the mount action repository 210 along with the second target application bundle (the second installation package). The mount action repository 210 also includes other versions of installation packages, for example the first installation package.

The mount action broadcast agent module 215 detects a change, for example storing of the second mount action version, in the mount action repository 210. The mount action broadcast agent module 215 further generates the mount action change event message which is broadcasted over the network 110. In an example, the mount action change event message includes information associated with the mount action definitions, with information associated a mount action change event schedule, and specifications of the target node 115. The information associated with the mount action definitions include source location of the application executable and relevant libraries and target mount point name. The source location can be from a local or remote file or directory which can be seamlessly mounted as a local resource. The information associated with the mount action change event schedule includes scheduled time intervals of when the at least one target process is to be controlled. For example, the mount action change event can be applied at a time interval without delay (instantly) or the mount action change event can be applied at a time interval with delay (at a later time). In an example, a user preferred reminder can also be assigned to a change event. The specifications of the target node 115 include internet protocol (IP), hostname, geospatial data to locate target nodes in a specific location. The specifications of the target node 115 can also be made available based on location of the target node 115.

FIG. 3 is a block diagram representation 300 of the target node 115, in accordance with one embodiment. The target node 115 includes an event processor 305. The event processor 305 includes a listener agent module 310. The listener agent module 310 further includes a change event validator module 315 and a change event scheduler module 320.

The listener agent module 310 includes an application boot strap component that listens for any incoming mount action change event messages for the at least one target process of the target application from the build server 105. The mount action change event message includes information corresponding to the second mount action version built for the second installation package. Once the mount action change event message is broadcasted over the network 110 by the build server 105, the listener agent module 310 can receive the mount action change event message. In an example, the mount action change event message can use UDP, TCP, or other underlying network protocols for being broadcasted over the network 110. The change event validator module 315 verifies if the mount action change event message is relevant or applicable for the target node 115. If the mount action change event message is not relevant for the target node 115, the mount action change event message is dropped by the change event validator module 315. If the mount action change event message is relevant for the target node 115, the second installation package is automatically obtained (or downloaded) from the build server 105. The second installation package is automatically obtained due to the user providing pre-authorization (for automatic download of installation packages) initially at time of installation. In other embodiments, the second installation package can be automatically obtained by setting appropriate system properties or configuration files, which would be used by the listener agent module 310 to take appropriate decisions. In some embodiments, the change event validator module 315 can notify the user to provide authorization to continue with download and processing of the mount action change event message. In an example, the user can decide to cancel or move the download and the processing of the mount action change event message into a later time interval. On obtaining the second installation package, the application boot strap component extracts the second installation package into a file system under a local repository. The file system is different from an underlying root file system of the target node 115 such that the underlying root file system is not overwritten or disturbed. The application boot strap component organizes and stores each installation package under separate file systems or folders to facilitate instant and easy roll back. Additionally, the application boot strap component also stores information associated with the mount action change event message in order to enable invoking of latest mount action versions during a rebooting process.

The change event scheduler module 320 checks the scheduled time interval of applying a change event to the at least one target process. The scheduled time interval can include the time interval without delay or the time interval with delay. The application boot strap component identifies and controls the at least one target process at the scheduled time interval based on the second installation package. The at least one target process is controlled by one of stopping the at least one target process and starting the at least one target process.

The application boot strap component of the listener agent module 310 further creates an isolated mount runtime environment for the at least one target process based on the second mount action version. The isolated mount runtime environment is created by creating a clone mount namespace for the at least one target process and sending appropriate mount point requests to underlying operating system of the target node 115. The application boot strap component further performs one or more mount actions for the at least one target process in response to the clone mount namespace that is created. The one or more mount actions are performed based on the second mount action version. The at least one target process is subsequently initiated by the application boot strap component from the isolated mount runtime environment to enable visibility of the one or more mount actions. Application data files and folders are further referenced from previous installation packages, for example the first installation package. Such referencing allows seamless data migration during boot strapping of the at least one target process based on the second installation package.

Different mount actions can be performed based on information, for example the geospatial data, in the mount action change event message. In one example, if a user of the target node 115 (a mobile device) walks into a restaurant, the user can view a menu card of the restaurant automatically on the mobile device. In another example, if the user is in a hospital reception area, a list of available specialists or capabilities are loaded automatically onto the mobile device. Such information can be made available based on user preferred subscription to information types or locality.

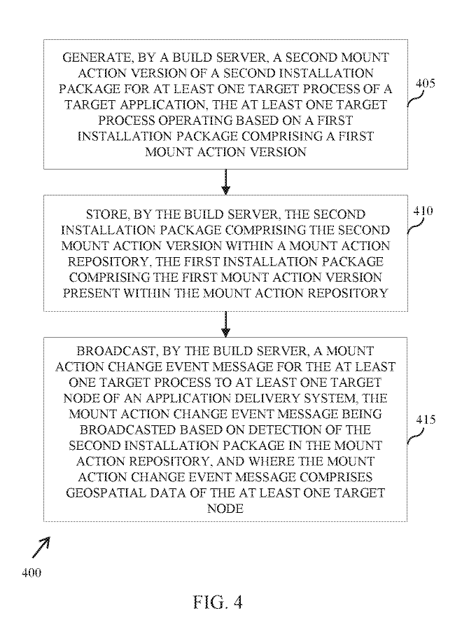

If the at least one target process is initiated successfully, the application boot strap component applies one or more system configurations to the at least one target process. Examples of the one or more system configurations include system resources, security policies, and the like. If the at least one target process is initiated unsuccessfully, the application boot strap component reverts (or rolls back) the at least one target process to the first mount action version of the first installation package. The application boot strap component goes back to creating another clone mount namespace to result in initiating of the at least one target process. However, in some embodiments, if the at least one target process is initiated unsuccessfully in repetition the application boot strap component broadcasts at least one log message to the build server 105. In some embodiments, the target node is based on a stateless application delivery model in which users can run one or more versions of an application in parallel. For example, the first mount action version and the second mount action version can be run in parallel. Such operation can be automated from the build server 105 or by invoking appropriate interface commands of the listener agent module 310 on the target node 115. An example method for managing micro release automation in an application delivery system by the build server 105 is explained with reference to FIG. 4.

FIG. 4 illustrates an example flow diagram of a method 400 for managing micro release automation in an application delivery system by a build server, for example the build server 105 in the application delivery system 100 of FIG. 1, in accordance with an embodiment. At step 405, the method 400 includes generating a second mount action version of a second installation package for at least one target process of a target application. The at least one target process operates based on a first installation package including a first mount action version. The second mount action version is generated or built using a mount action command generator, for example the mount action command generator 205 of the build server 105 of FIG. 2. A plurality of mount action definitions are defined during generation of the second mount action version. The method of generating the second mount action version by the mount action command generator is explained with reference to FIG. 2 and is not explained herein for sake of brevity.

In some embodiments, in a multi-user environment including multiple target nodes and build servers, target processes would be started with respective user access permissions and security policies. Similarly, in a multi-tenant environment, changes can be directed to be applied to particular tenant or user group.

At step 410, the method includes storing the second installation package including the second mount action version within a mount action repository, for example the mount action repository 210 of FIG. 2. The first installation package including the first mount action version is also present within the mount action repository in the mount action repository. The build server stores the second installation package in the mount action repository.

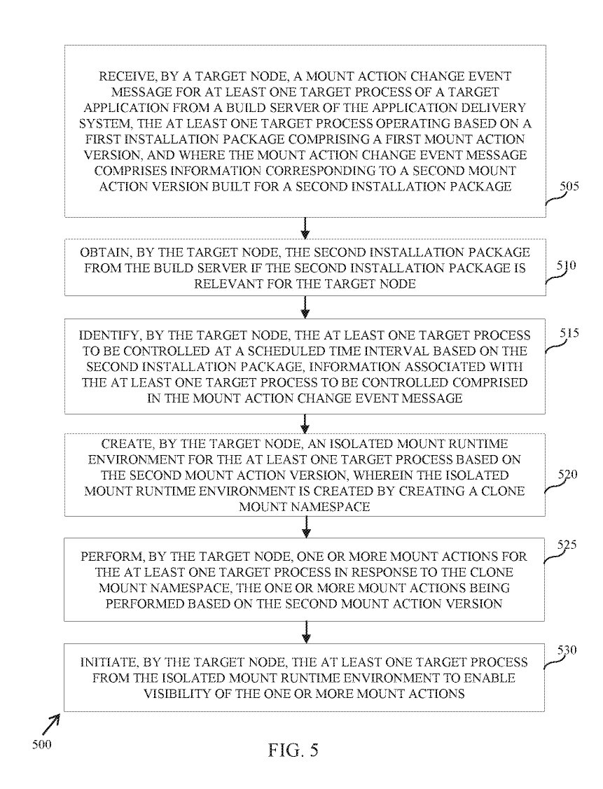

At step 415, the method includes broadcasting a mount action change event message for the at least one target process to at least one target node of the application delivery system. The mount action change event message is broadcasted by a mount action broadcast agent module, for example the mount action broadcast agent module 215 of FIG. 2, based on detection of the second installation package in the mount action repository. The mount action change event message includes geospatial data of the at least one target node in addition to other information, for example a mount action change event schedule. The mount action change event schedule includes scheduled time intervals associated with controlling of the at least one target process. The mount action change event message and operations of the mount action broadcast agent module is explained in detail with reference to FIG. 2 and is not explained herein for sake of brevity. An example method for managing micro release automation in an application delivery system by the target node is explained with reference to FIG. 5.

FIG. 5 illustrates an example flow diagram of a method 500 for managing micro release automation in an application delivery system by a target node, for example the target node 115 in the application delivery system 100 of FIG. 1, in accordance with an embodiment. At step 505, the method includes receiving a mount action change event message for at least one target process of a target application from a build server of the application delivery system. The at least one target process operates based on a first installation package including a first mount action version. The mount action change event message includes information corresponding to a second mount action version built for a second installation package. A listener agent module of an event processor, for example the listener agent module 310 of the event processor 305 of FIG. 3, in the target node listens and receives the mount action change event message with help of an application boot strap component. The method of receiving the mount action change event message is explained with reference to FIG. 3 and is not explained herein for sake of brevity.

Relevancy of the mount action change event message is verified for the target node. Such verification is performed using a change event validator module, for example the change event validator module 315 of FIG. 3, of the listener agent module. The method of verification is explained with reference to FIG. 3 and is not explained herein for sake of brevity.

At step 510, the method includes obtaining the second installation package from the build server if the second installation package is relevant for the target node. If the mount action change event message is relevant for the target node, the second installation package is automatically obtained (or downloaded) from the build server by the listener agent module. The second installation package is automatically obtained due to the user providing pre-authorization (for automatic download of installation packages) initially at time of installation. In other embodiments, the second installation package can be automatically obtained by setting appropriate system properties or configuration files, which would be used by the listener agent module 310 to take appropriate decisions. In some embodiments, the change event validator module 315 can notify the user to provide authorization to continue with download and processing of the mount action change event message. In an example, the user can decide to cancel or move the download and the processing of the mount action change event message into a later time interval. The second installation package is further extracted into a file system that is different from an underlying root file system of the target node.

In some embodiments, there is no availability of the first installation package, including the first mount action version, with the target node. In such cases, the target node receives the mount action change event message from the build server and subsequently obtains the second installation package. The second installation package will then be considered as the first installation package and the second mount action version will be considered as the first mount action version.

In other embodiments, if the first mount action version is not available, then information associated with the mount action change event message will be considered as the first mount action version. In such cases, the target node can create the first mount action version of the target application by following one or more mount actions as per a change event.

At step 515, the method includes identifying the at least one target process to be controlled at a scheduled time interval based on the second installation package. The at least one target process is identified using the application boot strap component and is controlled by one of starting the at least one target process and stopping the at least one target process. The scheduled time interval includes one of a time interval without delay and a time interval with delay. The scheduled time interval is further determined using a change event scheduler module, for example the change event scheduler module 320 of FIG. 3, of the listener agent module. The scheduled time interval can include a time interval without delay or a time interval with delay.

At step 520, the method includes creating an isolated mount runtime environment for the at least one target process based on the second mount action version. The isolated mount runtime environment is created by the application boot strap component by creating a clone mount namespace. The method of creating an isolated mount runtime environment and the clone mount namespace is explained with reference to FIG. 3 and is not explained herein for sake of brevity.

At step 525, the method includes performing one or more mount actions for the at least one target process in response to the clone mount namespace. The one or more mount actions are performed based on the second mount action version and are explained with reference to FIG. 3 and is not explained herein for sake of brevity. At step 530, the method includes initiating the at least one target process from the isolated mount runtime environment to enable visibility of the one or more mount actions.

If the at least one target process is initiated successfully, one or more system configurations are applied to the at least one target process. If the at least one target process is initiated unsuccessfully, the at least one target process is reverted to the first mount action version of the first installation package. Also, if the at least one target process is initiated unsuccessfully in repetition, at least one log message is broadcasted back to the build server.

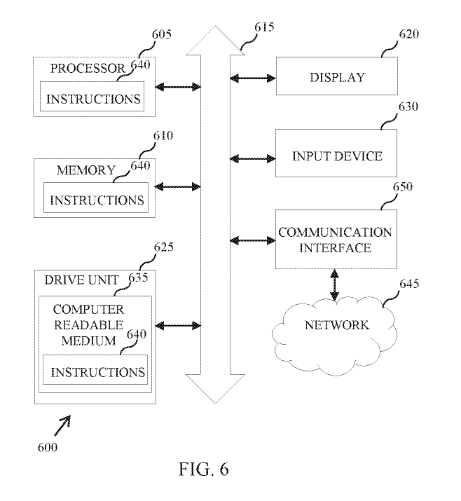

Referring to FIG. 6, illustrates a block diagram of an electronic device 600, which is representative of a hardware environment for practicing the present invention. The electronic device 600 can include a set of instructions that can be executed to cause the electronic device 600 to perform any one or more of the methods disclosed. The electronic device 600 may operate as a standalone device or can be connected, for example using a network, to other electronic devices or peripheral devices.

In a networked deployment of the present invention, the electronic device 600 may operate in the capacity of a build server, for example the build server 105 of FIG. 1, a target node, for example the target node 115 of FIG. 1, in a server-client user network environment, or as a peer electronic device in a peer-to-peer (or distributed) network environment. The electronic device 600 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single electronic device 600 is illustrated, the term “device” shall also be taken to include any collection of systems or sub-systems that individually or jointly execute a set, or multiple sets, of instructions to perform one or more computer functions.

The electronic device 600 can include a processor 605, for example a central processing unit (CPU), a graphics processing unit (GPU), or both. The processor 605 can be a component in a variety of systems. For example, the processor 605 can be part of a standard personal computer or a workstation. The processor 605 can be one or more general processors, digital signal processors, application specific integrated circuits, field programmable gate arrays, servers, networks, digital circuits, analog circuits, combinations thereof, or other now known or later developed devices for analyzing and processing data. The processor 605 can implement a software program, such as code generated manually (for example, programmed).

The electronic device 600 can include a memory 610, such as a memory 610 that can communicate via a bus 615. The memory 610 can include a main memory, a static memory, or a dynamic memory. The memory 610 can include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one example, the memory 610 includes a cache or random access memory for the processor 605. In alternative examples, the memory 610 is separate from the processor 605, such as a cache memory of a processor, the system memory, or other memory. The memory 610 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 610 is operable to store instructions executable by the processor 605. The functions, acts or tasks illustrated in the figures or described can be performed by the programmed processor 605 executing the instructions stored in the memory 610. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 600 can further include a display unit 620, for example a liquid crystal display (LCD), an organic light emitting diode (OLED), a flat panel display, a solid state display, a cathode ray tube (CRT), a projector, a printer or other now known or later developed display device for outputting determined information. The display 620 can act as an interface for a user to see the functioning of the processor 605, or specifically as an interface with the software stored in the memory 610 or in a drive unit 625.

Additionally, the electronic device 600 can include an input device 630 configured to allow the user to interact with any of the components of the electronic device 600. The input device 630 can include a stylus, a number pad, a keyboard, or a cursor control device, for example a mouse, or a joystick, touch screen display, remote control or any other device operative to interact with the electronic device 600.

The electronic device 600 can also include the drive unit 625. The drive unit 625 can include a computer-readable medium 635 in which one or more sets of instructions 640, for example software, can be embedded. Further, the instructions 640 can embody one or more of the methods or logic as described. In a particular example, the instructions 640 can reside completely, or at least partially, within the memory 610 or within the processor 605 during execution by the electronic device 600. The memory 610 and the processor 605 can also include computer-readable media as discussed above.

The present invention contemplates a computer-readable medium that includes instructions 640 or receives and executes the instructions 640 responsive to a propagated signal so that a device connected to a network 645 can communicate voice, video, audio, images or any other data over the network 645. Further, the instructions 645 can be transmitted or received over the network 645 via a communication port or communication interface 650 or using the bus 615. The communication interface 650 can be a part of the processor 605 or can be a separate component. The communication interface 650 can be created in software or can be a physical connection in hardware. The communication interface 650 can be configured to connect with the network 645, external media, the display 620, or any other components in the electronic device 600 or combinations thereof. The connection with the network 645 can be a physical connection, such as a wired Ethernet connection or can be established wirelessly as discussed later. Likewise, the additional connections with other components of the electronic device 600 can be physical connections or can be established wirelessly. The network 645 can alternatively be directly connected to the bus 615.

The network 645 can include wired networks, wireless networks, Ethernet AVB networks, or combinations thereof. The wireless network can include a cellular telephone network, an 802.11, 802.16, 802.20, 802.1Q or WiMax network. Further, the network 645 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 600.

One or more examples described can implement functions using two or more specific interconnected hardware modules or devices with related control and data signals that can be communicated between and through modules, or as portions of an application-specific integrated circuit. Accordingly, the present system encompasses software, firmware, and hardware implementations.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (for example, TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof

Various embodiments disclosed herein provide numerous advantages by providing a method and system for managing micro release automation in an application delivery system. The present invention delivers installation packages for target processes of a target application at high speeds and with more frequency in micro seconds. In case of any failure, roll back or reverting to previous versions of the installation packages are made possible instantly at any given point in time. The present invention provides a stateless application delivery model as no change is performed to underlying root file system. The present invention also provides on-demand application delivery based on location, time, geospatial data and other information. The present invention further enables the target process to be attached to a particular network segment by appropriate network capabilities available at the target node.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A computer-implemented method of managing micro release automation in an application delivery system, the method comprising:
generating, by a build server, a second mount action version of a second installation package for at least one target process of a target application, the at least one target process operating based on a first installation package comprising a first mount action version;
storing, by the build server, the second installation package comprising the second mount action version within a mount action repository, the first installation package comprising the first mount action version present within the mount action repository; and
broadcasting, by the build server, a mount action change event message for the at least one target process to at least one target node of the application delivery system, the mount action change event message being broadcasted based on detection of the second installation package in the mount action repository, and wherein the mount action change event message comprises geospatial data of the at least one target node.

2. The method as claimed in claim 1, wherein the second mount action version replaces the first mount action version during unavailability of the first mount action version within the mount action repository.

3. The method as claimed in claim 1, wherein generating the second mount action version comprises:
defining a plurality of mount action definitions.

4. The method as claimed in claim 3, wherein the mount action change event message comprises a mount action change event schedule, the mount action change event schedule comprising scheduled time intervals associated with controlling of the at least one target process.

5. A computer-implemented method of managing micro release automation in an application delivery system, the method comprising:
receiving, by a target node, a mount action change event message for at least one target process of a target application from a build server of the application delivery system, the at least one target process operating based on a first installation package comprising a first mount action version, and wherein the mount action change event message comprises information corresponding to a second mount action version built for a second installation package;
obtaining, by the target node, the second installation package from the build server if the second installation package is relevant for the target node;
identifying, by the target node, the at least one target process to be controlled at a scheduled time interval based on the second installation package, information associated with the at least one target process to be controlled comprised in the mount action change event message;
creating, by the target node, an isolated mount runtime environment for the at least one target process based on the second mount action version, wherein the isolated mount runtime environment is created by creating a clone mount namespace;
performing, by the target node, one or more mount actions for the at least one target process in response to the clone mount namespace, the one or more mount actions being performed based on the second mount action version; and
initiating, by the target node, the at least one target process from the isolated mount runtime environment to enable visibility of the one or more mount actions.

6. The method as claimed in claim 5, further comprising:
applying, by the target node, one or more system configurations to the at least one target process if the at least one target process is initiated successfully, information associated with the one or more system configurations comprised in the mount action change event message; and
reverting, by the target node, the at least one target process to the first mount action version of the first installation package if the at least one target process is initiated unsuccessfully.

7. The method as claimed in claim 6, further comprising one or more of:
broadcasting, by the target node, at least one log message to the build server if the at least one target process is initiated unsuccessfully in repetition; and
broadcasting, by the target node, one of a successful message and an unsuccessful message along with timestamp information to the build server based on the at least one target process being reverted to the first mount action version of the first installation package.

8. The method as claimed in claim 7, wherein receiving the mount action change event message comprises:
verifying, by the target node, if the mount action change event message is relevant for the target node.

9. The method as claimed in claim 8, wherein the second installation package is obtained subsequent to pre-authorization by a user of the target node.

10. The method as claimed in claim 9, wherein obtaining the second installation package further comprises:
extracting, by the target node, the second installation package into a file system, the file system being different from an underlying root file system of the target node.

11. The method as claimed in claim 10, wherein the at least one target process is controlled by one of starting the at least one target process and stopping the at least one target process, the scheduled time interval comprising one of a time interval without delay and a time interval with delay.

12. A build server implemented in an application delivery system, the build server in operative communication with at least one target node associated with the application delivery system, the build server comprising:
a mount action command generator configured to generate a second mount action version of a second installation package for at least one target process of a target application, the at least one target process operating based on a first installation package comprising a first mount action version;
a mount action repository coupled to the mount action command generator and configured to store the second installation package comprising the second mount action version, the first installation package comprising the first mount action version present within the mount action repository; and
a mount action broadcast agent coupled to the mount action repository and configured to broadcast a mount action change event message for the at least one target process to the at least one target node of the application delivery system, the mount action change event message being broadcasted based on detection of the second installation package in the mount action repository, and wherein the mount action change event message comprises geospatial data of the at least one target node.

13. The build server as claimed in claim 12, wherein the mount action command generator is further configured to define a plurality of mount action definitions.

14. The build server as claimed in claim 13, wherein the mount action change event message comprises a mount action change event schedule, the mount action change event schedule comprising scheduled time intervals associated with controlling of the at least one target process.

15. A target node implemented in an application delivery system, the target node in operative communication with a build server associated with the application delivery system, the target node comprising:
an event processor comprising:
a listener agent module configured to:
receive a mount action change event message for at least one target process of a target application from a build server of the application delivery system, the at least one target process operating based on a first installation package comprising a first mount action version, and wherein the mount action change event message comprises information corresponding to a second mount action version built for a second installation package;
obtain the second installation package from the build server if the second installation package is relevant for the target node;
identify the at least one target process to be controlled at a scheduled time interval based on the second installation package, information associated with the at least one target process to be controlled comprised in the mount action change event message;
create an isolated mount runtime environment for the at least one target process based on the second mount action version, wherein the isolated mount runtime environment is created by creating a clone mount namespace;
perform one or more mount actions for the at least one target process in response to the clone mount namespace, the one or more mount actions being performed based on the second mount action version; and
initiate the at least one target process from the isolated mount runtime environment to enable visibility of the one or more mount actions.

16. The target node as claimed in claim 15, wherein the listener agent module is further configured to:
apply one or more system configurations to the at least one target process if the at least one target process is initiated successfully; and
revert the at least one target process to the first mount action version of the first installation package if the at least one target process is initiated unsuccessfully.

17. The target node as claimed in claim 16, wherein the listener agent module is further configured to perform one or more of:
broadcast at least one log message to the build server if the at least one target process is initiated unsuccessfully in repetition; and
broadcast one of a successful message and an unsuccessful message along with timestamp information to the build server based on the at least one target process being reverted to the first mount action version of the first installation package.

18. The target node as claimed in claim 17, wherein the listener agent module comprises:
a change event validator module to verify if the mount action change event message is relevant for the target node.

19. The target node as claimed in claim 18, wherein the listener agent module is configured to:
extract the second installation package into a file system, the file system being different from an underlying root file system of the target node; and
invoke the second mount action version during a rebooting process based on information associated with the mount action change event message being stored on the target node.

20. The target node as claimed in claim 19, wherein the listener agent module comprises:
a change event scheduler module configured to check the scheduled time interval to control the at least one target process, the at least one target process controlled by one of starting the at least one target process and stopping the at least one target process, the scheduled time interval comprising one of a time interval without delay and a time interval with delay.

21. The target node as claimed in claim 20, wherein the target node is configured to attach one or more configuration files using a network protocol as specified in the mount action change event message.

22. The target node as claimed in claim 21, wherein the target node is based on a stateless application delivery model.
